(19) United States
(12) Patent Application Publication
(10) Pub. No.: US 2004/0002781 A1
(43) Pub. Date: Jan. 1, 2004

(54) Methods and apparatuses for adjusting sonic balace in audio reproduction systems

(76) Inventor: Keith O. Johnson, Pacifica, CA (US)

Correspondence Address: LEE & HAYES PLLC, 421 W RIVERSIDE AVENUE SUITE 500, SPOKANE, WA, 99201

(21) Appl. No.: 10/185,756

(22) Filed: Jun. 28, 2002

(51) Int. Cl. G06F 17/00

(52) U.S. Cl. 700/94

(57) ABSTRACT

Methods and apparatuses are provided for correcting or otherwise modifying audio signals based on a variety of parameters. One apparatus includes parameter selecting logic that determines one or more audio signal parameter settings, and rule book logic that determines if the audio signal parameter settings are allowable for the audio reproduction system configuration and then establishes an appropriate parameter code. The apparatus further includes correction logic that receives or accesses an audio data signal and based on the parameter code applies audio signal parameter settings to at least a portion of the audio data signal to modify the audio data signal.

### TECHNICAL FIELD

This invention relates to audio reproduction, and more particularly to methods and apparatuses for selectively adjusting at least certain portions of the audio signal information being reproduced by an audio reproduction system.

### BACKGROUND

Audio reproduction systems attempt to faithfully reproduce sounds that have been recorded or otherwise included within a source audio signal. However, usually there are limitations associated with the audio reproduction system that often prevent the system from reproducing a perfect replica of the original/intended sounds. One reason for this imperfection is that speaker(s) employed in the various system configurations exhibit certain sonic qualities that in someway tend to limit their ability to perfectly reproduce sounds. For example, most speakers have inherent resonant frequencies that may alter or otherwise affect the reproduced sounds.

Thus, for this reason and others, there is a continuing movement in the audio equipment industry to provide improved speakers and other related components. It would be beneficial for an audio reproduction system to be able to consider the sonic capabilities/qualities of their speakers during the processing of the audio signal that is being reproduced.

### SUMMARY

In accordance with certain aspects of the present invention, improved audio signal compensation and/or equalization techniques, methods and apparatuses are provided. These improvements may, for example, be implemented for speaker(s) in audio reproduction (e.g., sound) systems in such a manner that the sonic balance of an audio signal can be adjusted without boosting undesirable coloration and distortion and/or suppressing clarity and resolution in the resulting reproduced sound.

Certain methods and apparatuses are provided for correcting audio signals based on a variety of parameters. One exemplary apparatus includes parameter selecting logic that determines one or more audio signal parameter settings, and rule book logic that determines if the audio signal parameter settings are allowable for the audio reproduction system configuration and then establishes an appropriate parameter code. The apparatus further includes correction logic that receives an audio data signal and based on the parameter code applies audio signal parameter settings to at least a portion of the audio data signal to modify the audio data signal and hence the reproduced sounds.

### BRIEF DESCRIPTION OF THE DRAWINGS

The present invention is illustrated by way of example in the figures of the accompanying drawings. The same numbers are used throughout the figures to reference like components and/or features.

FIG. 1 is a block diagram illustrating an exemplary audio reproduction system having at least one audio data source, an audio processing device and at least one speaker, in accordance with certain implementations of the present invention.

FIG. 2 is a block diagram illustrating certain features of an exemplary audio processing device, for example, as in FIG. 1, in accordance with certain further implementations of the present invention.

FIG. 3 is a flow diagram illustrating an exemplary process that can be implemented in an audio processing device, for example, as in FIG. 2, in accordance with certain implementations of the present invention.

FIG. 4 is an illustrative diagram depicting a portion of an exemplary parameter code, for example, as established in the process in FIG. 3, in accordance with certain implementations of the present invention.

FIG. 5 is a graph depicting the transfer function response of an audio reproduction system, for example, as in FIG. 1, for an audio signal having frequencies between about 40 Hz and about 20,000 Hz, and with and without the shown exemplary correction applied, in accordance with certain implementations of the present invention.

FIG. 6 is a waterfall (time-energy) graph depicting the cumulative spectral decay of an audio reproduction system, for example, as in FIG. 1, processing an audio signal without correction, which illustrates, for example, internal reflections, counterproductive interference, breakup modes, and/or resonances, for example, associated with an exemplary speaker arrangement as measured very near a speaker, in accordance with certain implementations of the present invention.

FIG. 7 is a waterfall (time-energy) graph depicting the cumulative spectral decay of an audio reproduction system, for example, as in FIG. 1, processing an audio signal without correction, which illustrates, for example, certain frequencies or frequency bands, for example, associated with an exemplary speaker arrangement as measured as bouncing off of a supporting surface, in accordance with certain implementations of the present invention.

FIG. 8 is a graph depicting a range of transfer function responses of an audio reproduction system, for example, as in FIG. 1, for certain lower frequencies of an audio signal having frequencies between about 30 Hz and about 20,000 Hz, and with exemplary correction applied, in accordance with certain implementations of the present invention.

FIG. 9 is a graph depicting a range of transfer function responses of an audio reproduction system, for example, as in FIG. 1, for certain upper frequencies of an audio signal having frequencies between about 40 Hz and about 20,000 Hz, and with exemplary correction applied, in accordance with certain implementations of the present invention.

FIG. 10 is a graph further depicting a range of upper midband transfer function responses of an audio reproduction system, for example, as in FIG. 1, for certain upper frequencies of an audio signal having frequencies between about 40 Hz and about 20,000 Hz, and with exemplary correction applied, in accordance with certain implementations of the present invention.

FIG. 11 is a graph depicting an exemplary acoustic response of a speaker arrangement for different toned control settings of an audio reproduction system, for example, as in FIG. 1, with correction applied, in accordance with certain implementations of the present invention.

FIG. 12 is a graph depicting an exemplary acoustic response of a speaker arrangement of an audio reproduction system, for example, as in FIG. 1, for different audio source signals with correction applied accordingly, in accordance with certain further implementations of the present invention.

FIG. 13 is a block diagram depicting a general computing device that may be configured as an audio processing device, for example, as in FIG. 1, in accordance with certain further implementations of the present invention.

### DETAILED DESCRIPTION

In accordance with certain aspects of the present invention, improved audio signal compensation or equalization techniques, methods and apparatuses are provided. These improvements can be implemented for speaker(s) in audio reproduction (sound) systems in such a manner that the sonic balance of an audio signal can be adjusted without boosting undesirable coloration and distortion and/or suppressing clarity and resolution in the resulting reproduced sound.

The improvements provided herein are adaptable to a wide variety of audio reproduction devices and arrangements. In certain implementations, for example, an improved equalizer is provided, which can be implemented in digital and/or analog sound systems. Thus, by way of example and not limitation, the improvements can be implemented in equalization systems such as those described in related U.S. patent application Ser. No. 60/148,412, titled “Compensation System and Method for Sound Reproduction”, and which is incorporated by reference, in its entirety, herein.

Those skilled in the art will recognize that the improvements can be implemented in systems/devices to support the manual control of a user and/or the automated control of sonic balancing logic, etc. Thus, for example, in certain implementations, a user may adjust physical and/or graphically displayed tone controls or graphic equalizers. In other implementations, automatic equalizers may be employed.

By way of introduction, in accordance with certain aspects of the present invention, the improvements include receiving and/or otherwise recognizing profile information about a specific speaker model, design or system constraint, and adjusting the audio signal that is to be reproduced by the speaker in such a way to avoid equalizing or otherwise exacerbating known problems or limitations of the speaker/system. In accordance with certain other aspects of the present invention, the audio signal may be adjusted based on certain listening preferences and/or capabilities of the user, the environment, and/or the type of source audio information.

With this in mind, an exemplary speaker compensation system may include an aggregate of parametrically tuned filters and/or other like processes created by logic, circuits or DSP operations, for example. Generally, some of these filters are resonant and tuned to suppress counterproductive sound reproduction that would occur from motion breakup, standing waves and resonant behavior typical of speaker parts and related acoustic behavior. Other resonators create additive responses to compensate or restore an averaged flattened frequency response near the correction. Where possible, these compensation filters are tuned to boost those frequencies having better mechanical and acoustic behavior from the speaker components. Simple tone control-like equalizer elements are often added to the aggregate filter responses to either flatten or contour frequency response of the speaker system for technical or marketing requirements.

Parameter settings for this exemplary compensation system can be uniquely established for certain speaker designs, technical performance data or predetermined generic properties of families of speakers, for example. Tuning information to make these settings may be compiled from measurements, design analysis, or the use of equivalent behavioral models or templates for speakers and acoustics. This information and profile compilations can then be checked for subjective audibility and portions thereof sorted and discarded so that the most audible or objectionable behavior is selected to create subtractive filter choices and related parametric settings. In this manner, objectionable sounds from breakup, standing waves, resonance, as well as interactions of listening environment to speaker and listener can be identified and significantly attenuated or removed.

In certain exemplary systems, a group of filters, each one having subtle effect can be employed to reduce a sonic annoyance. As noted before, for example, such aggregate subtractive processes suppress output from the speaker and the resulting nasality of sound is compensated or removed by additive resonant filters tuned near or to either side or both sides of the subtractive correction dips. These boosts can be placed to enhance speaker output known to have better acousto-mechanical properties. Generally, the resulting additive—subtractive filter aggregate is adjusted to restore an averaged frequency response to be somewhat like it was prior to correction. However, other parametric tunings can align the aggregate to change sonic balance or to become a part of an improvement to another system such as, e.g., a codec. The system of filters and tuning can be determined and set from profile data (e.g., included in parameter code) that can change for different speakers and for different circumstances in other parts of the sound reproduction chain.

The exemplary filter configurations with alignment as described above may also have parametric controls that are linked through a process which operates from user commands and/or automatically actuated systems. Thus, in certain implementations, commands to control processes can change certain parameters in the correction system to contour frequency responses in ways expected from an equalizer. For example, one equalization change may be made when the balance of subtraction processes for counter-productive output and boost processes for good behavior is shifted either upwards or downwards. In this manner, an adjustment command for more equalization or output in a given frequency range boosts good behavior while a decreasing one removes more of the bad or counter-productive behavior.

Speaker correction and many equalizer systems may have architectural similarities since they contain multiple filter processes or the equivalent of circuit networks having similar responses. Consequently, the two operations, speaker correction and adjustable equalization may be combined together and realized as one system or the operations can be dispersed and functionally linked to reside in more than one module/subsystem in a large system.

For example, a graphic equalizer may be modified or augmented to produce speaker correction responses. In a like manner, a correction system may be modified or augmented to produce user adjustable responses similar to an equalizer. Dedicated designs can produce both functions. Any of the above compensating equalizer systems can be configured to use information profiles (e.g., as incorporated in parameter code) created for a specific speaker design, model, measurement or other requirement or from measurement data.

Furthermore, any of these process systems may have their user and adjustment commands restricted, re-directed or modified to best-fit speaker performance. To do this, for example, user and equalizer control inputs may be modified by rule book logic, profile information, system state, program conditions, etc. Thus, such a compensating equalizer may restrict or redirect user settings of high-energy boost away from easily overloaded stress frequencies of a speaker, receive system bandwidth information and shift a user setting compensating, and/or imposing soft limit spectrums to reduce overload or create louder playback based on user and speaker data.

In accordance with certain further implementations, such compensating equalizers that operate from profile settings can be configured to selectively boost bass without bringing up resonant behavior, add presence without introducing harsh cone cry or breakup, and/or increase treble without adding hash or noise. Similarly, an equalizer may reduce these energy bands by increasing the removal of unwanted sonic behavior thereby enhancing the correction or compensation method. Profiles (e.g., selected parameters) can make this action unique and best suited for the speaker type.

Additional or redundant equalization elements or filters may be included to simplify programming requirements needed to profile certain speakers and/or to improve the resulting equalization range. Here, for example, a boost may be applied to good behavior and appropriate notches configured to remove counterproductive output where possible.

A different action may occur when a user seeks to attenuate some part of the frequency range. Here, in certain arrangements, the rule book may be configured to prevent boosting counterproductive output when more equalization is sought. A system like this, for example, benefits from a decoding rule book so that user commands can control and operate the various linked parameters properly to produce equalizer like responses. In certain instances, this type of correction system may be better able to create new and unique product features such as equalization families for different kinds of musical programs, personal tastes and the like.

A user may decide to adjust various controls/inputs in many different ways, the result of which could cause distortion or other problems particularly for a narrow range of overload prone bass frequencies, for example. For such situations, modeled speaker information and correction profiles or other like information may be used to re-direct or more evenly distribute, over a range of frequencies, a maximum estimated stress power to the speaker(s) for example. Otherwise, unless some other action is taken, severe boost equalization will likely exceed reasonable limits to cause overload and distorted sound. In accordance with certain implementations, therefore, profile information or the like about overload prone frequencies, for example, may be used to set control interfaces for user and automatic adjustments to limit or bracket equalization action to prevent distortion.

Other related methods can be activated from such information too. For example, equalization responses from user commands may be restricted when user commands at bass overload frequencies call for large overload prone boosts. Adjacent frequencies may be boosted instead of, or along with, overload prone frequencies to achieve a subjective equalization effect for large boosts, maximum equalization at stress frequencies can be limited either all of the time or dynamically changed and made dependant on program activity and volume control settings when known, and/or other variations of these methods can be applied for midrange equalization to redirect user commands to frequencies offering better speaker performance. For any of these systems and methods, the user controls and their apparent operation and functional behavior to the user may appear unchanged.

Speaker correction rules, for example, may be interposed so that new internal commands to filters are created for a graphics equalizer. Thus, when boosts (increases in gain) are wanted near or at a frequency known to have counter-productive behavior from the speaker, the user or automatic commands may be steered away from counterproductive behavior and toward adjacent frequencies known to have less breakup or other problems. Restricted maximum boosts for overload prone frequencies can be imposed as fixed and/or dynamic operations as previously described. In a like manner, cuts (reductions in gain) can be redirected to favor those frequencies that have behavioral problems from the speaker. As before, the system may be optimized to the speaker and controls and functional behavior for this augmented system configured to appear unchanged to the user.

Certain exemplary compensated equalizers include more filter elements than user adjustments so that programming of the control processor that changes filter settings can be simplified. In addition, the filter lineup creating a graphic architecture can be tapered to favor more resonators of narrower bandwidth at midrange frequencies where corrections are more likely and equalizer performance should be better to accommodate human hearing acuity.

In accordance with certain other aspects of the present invention, the modeled equalization system may re-scale settings to accommodate other operations or processes used for sound reproduction. For example, one may move an end of band peaking equalization that might be set by a user. A user may boost a high frequency to get more clarity or sonic crispness, which tends to work provided that there are high frequencies to boost. Whereas CD and high quality down load music may cover most of the audio range, other program sources from a computer, for example, may not. These lower bandwidth sources can sound dull from a system peaked for high quality reproduction. To eliminate a compromise, the modeled equalizer can be made to shift the end band peaking frequency set by a user to match or be more compatible with the bandwidth potential or capability of the program (e.g., source data signal). In certain systems, for this method to work properly, the boost setting made by the user can be retained in the frequency move and speaker compensation made active to prevent double boosting on an existing speaker resonance.

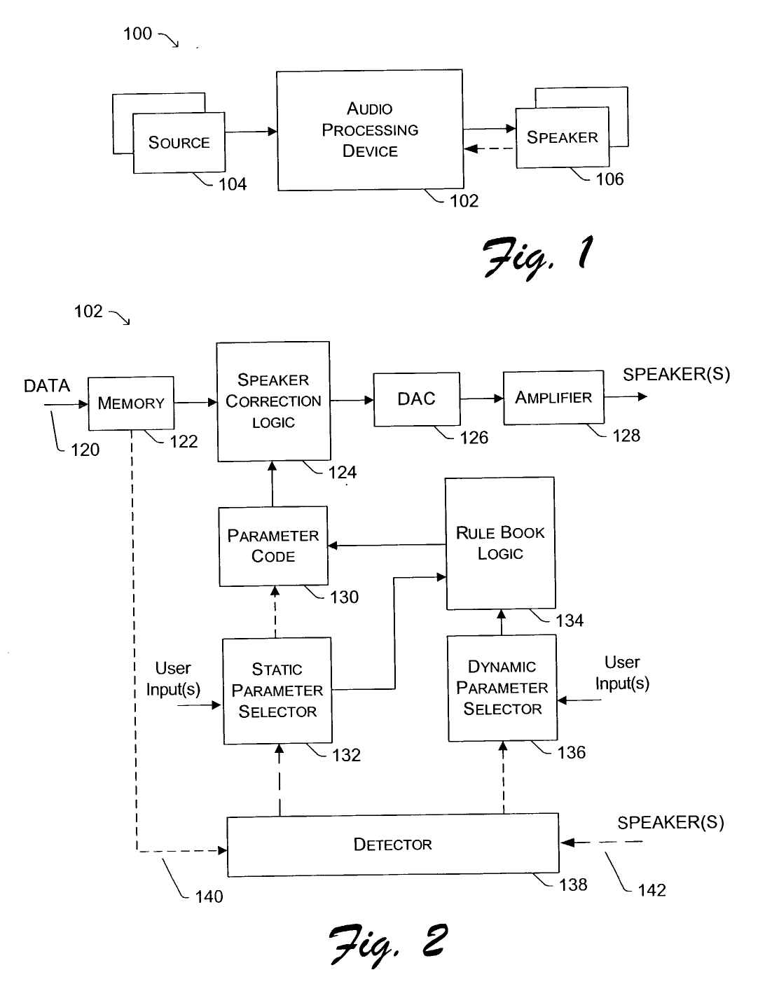

With the above techniques in mind, FIG. 1 is a block diagram illustrating an exemplary audio reproduction system 100 having at least one audio data source 104, an audio processing device 102 and at least one speaker 106, in accordance with certain implementations of the present invention.

Although depicted as being separate, it is recognized that audio data source 104, audio processing device 102 and/or speaker 106 can be combined within one device or appliance. For example, in certain instances, audio reproduction system 100 may include a personal computer (PC) having a source audio file(s) stored in memory or other like computer-readable medium, an audio processing capability provided by logic, and one or more speakers. In other implementations, system 100 may be found in a smaller more portable device, such as, for example, a portable sound device, MP3 player, personal digital assistant, mobile communication device, etc. In certain implementations, speaker 106 may include one or more headphones. Also, in certain implementations, source 104 may be available from a remote device or service, such as, for example, a server or other like device that is connected to audio processing device 102 over one or more networks, etc.

While it is assumed in the following further examples that the improved signal correction/equalization occur mostly within audio processing device 102, it is recognized that in other implementations, such improvements can be distributed or redistributed to one or more of source 104, audio processing device 102, and speaker 106.

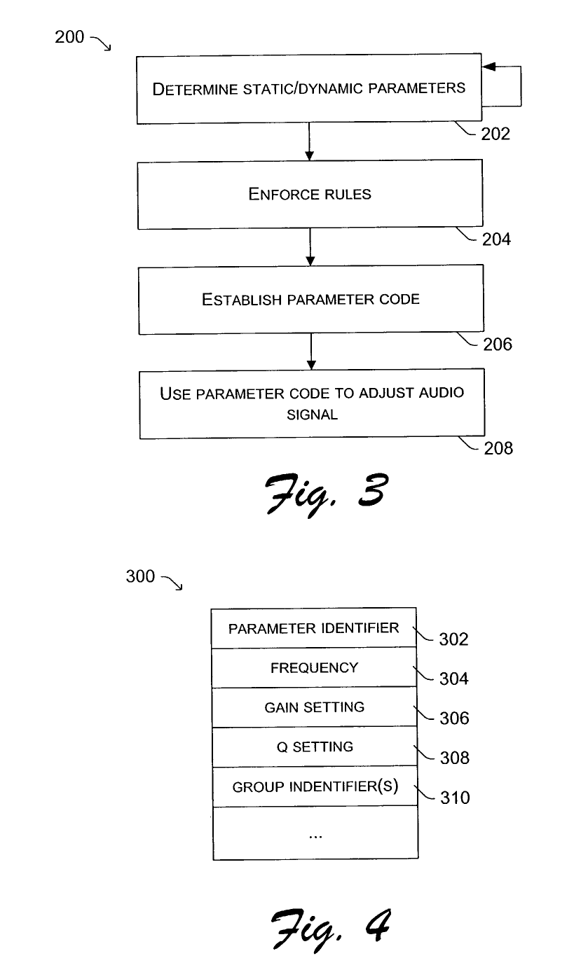

With this in mind, attention is drawn to FIG. 2, which is a block diagram illustrating certain features of an exemplary audio processing device 102 that is configured to provide the improvements introduced above, in accordance with certain implementations of the present invention.

Here, audio processing device 102 is configured to receive digital audio signal data 120 from a source 104 and output at least one corresponding corrected analog audio signal to speaker(s) 106. To accomplish this task, the digital audio signal data can be buffered in a memory 122 and accessed by speaker correction logic 124. Memory 122, for example, may include random access memory (RAM), read only memory (ROM), or other like data holding mechanism. Speaker correction logic 124 may include hardware, firmware, software, or any combination thereof. In certain implementations, for example, speaker correction logic 124 includes one or more digital signal processors (DSPs) that are configurable to selectively modify data 120 in accordance with instructions and or information maintained or otherwise provided in parameter code 130. Parameter code 130 is described in greater detail in subsequent sections.

The output of speaker correction logic 124 includes corrected digital audio signal data. The corrected digital audio signal data is then provided to a digital-to-analog converter (DAC) or other like mechanism that converts the corrected digital audio signal data into at least one corresponding corrected analog audio signal. The corrected analog audio signal is then provided to at least one amplifier 128, which outputs at least one corresponding amplified audio signal suitable for driving at least one speaker. Note that in certain implementations, DAC 126 and/or amplifier 128 may be providing within a speaker device along with the one or more speakers.

As mentioned above, parameter code 130 is configured to cause speaker correction logic 124 to selectively make adjustments to at least portions of data 120. In accordance with certain exemplary implementations, parameter code 130 is configured to account for various characteristics of speaker 106 that are either audibly desirable and therefore preferably maintained or perhaps even boosted, and/or audibly undesirable and therefore preferably avoided or perhaps attenuated in the resulting corrected digital audio signal data. Similarly, in accordance with still other exemplary implementations, parameter code 130 can be configured to account for various characteristics of the listening user and/or environment that are either audibly contribute too or degrade the listening process. In accordance with further exemplary implementations, parameter code 130 can be configured to account for various characteristics of data 120, such as, for example, a digital sampling rate, a source identifier, etc.

Parameter code 130 can take on a variety of forms. In certain implementations, parameter code 130 includes parameter settings that define what changes, if any, are to be applied to data 120 by speaker correction logic 124. Thus, for example, attention is directed to FIG. 4, which is an illustrative diagram depicting a portion of a parameter code file 300, in accordance with certain exemplary implementations of the present invention. Here, parameter code file 300 may include a parameter identifier 302, a frequency 304, a gain setting 306, a Q setting 308, one or more group identifiers 310, and/or other like information that is useful in defining the portion(s) of data 120 to adjust and what adjustments are to be made. Speaker correction parameters may include operations involving time delay and time delay systems with feedback loops to simulate wall reflections and bounce from table tops. These time delay operations are not ordinarily changed by systems changing sonic balance. However they could be changed with the Draft system as part of a frequency response correction that tracks listener position as described later.

All or part of the information in 302-310 can be provided for one or more frequencies, frequency bands, groups of frequencies, groups of frequency bands, delay parameters, etc., as represented in file 300.

In certain implementations, only a frequency 304 and gain setting 306 are defined for frequencies that need to be corrected in some manner, e.g., boosted or cut. Parameter identifier 302 may include a unique identifier for one or more frequencies, frequency bands, groups of frequencies, groups of frequency bands, notches, delay operations, etc., identifiable within the audio signal. Frequency 304 identifies one or more frequencies that are to be corrected. Gain setting 306, in this example, identifies positive (boost) or negative (cut) gains that are to be applied in adjusting the audio signal at the applicable frequencies as identified in frequency 304 (and/or related to parameter identifier 302 or group identifier(s) 310). Hence, for example, frequency 304 may define a frequency of 600 Hz and associated gain setting 306 may define a boost of +2 dB. As such, speaker correction logic 124 would apply a 2 dB gain to the portion of data 120 associated with the audio frequency of 600 Hz. For 2200 Hz, a cut of −6 dB may be made in the same manner.

Q setting 308 is provided to define the Q for the filter(s) that is employed to boost and/or cut data 120. Thus, in certain exemplary systems, Q setting 308 essentially defines how the correction should be implemented with regard to the defined frequency and surrounding frequencies. A higher Q setting will in certain implementations result in a more narrow correction, while a lower Q setting will result in a wider correction. Thus, for example, if it is desired to remove/reduce undesirable audio frequencies, then a notch filter or the like may be provided by speaker correction logic and configured accordingly and with a Q that effectively causes the corresponding correction to data 120.

Group identifier(s) 310 may be employed to define one or more parameters to be grouped together and receive the same corrections. Thus, for example, a group of frequencies may be established and each identified as belonging to the same group and the correction identified for this group being applied to each of the frequencies in the group of frequencies.

Rule book logic 134 can be configured to account for bass maximum/minimum settings, treble maximum/minimum settings, cone cry frequencies/notches, resonances/notches, etc., associated with speaker 106.

Returning to FIG. 2, parameter code 130 can be established either manually or automatically, depending upon the design of system 100. In this example, parameter code 130 is adjustable by rule book logic 134 and/or (optionally) by static parameter selector 132. Here, rule book logic 134 defines and enforces limitations as to the settings of parameter code 130. Thus, for example, an upper gain (boost) limit, a lower gain (cut) limit, and/or one or more Q setting limits may be defined and enforced for one or more audio frequencies.

Static parameter selector 132 is configured to allow at least one predetermined speaker correction parameter associated with a specific type/model of speaker 106 to be included or otherwise applied to parameter code 130 directly (as an option) or indirectly through rule book logic 134. As such, static parameter selector 132 can be configured to receive or otherwise access/determine the one or more predefined speaker correction parameters and data or information for rule book setup. For example, static parameter selector 132 may be configured to allow a user to input information about speaker 106 that can then be used to access the applicable parameters either locally and/or remotely. Thus, if system 100 includes a PC, then a graphical user interface (GUI) may be supported by static parameter selector 132 and configured to allow the user to input information about speaker 106. The user may also insert a CD or other like computer-readable medium that includes such information and/or the parameters for speaker 106. In certain implementations, a network resource may be accessed to retrieve such information/parameters.

Static parameter selector 132 in certain exemplary implementations is further configured to interact with and/or otherwise receive correction parameter inputs from the user regarding the user's listening capabilities and/or preferences. Thus, for example, the user may input desired equalization or other correction parameters through a user interface. Here, the user interface may include a GUI and/or manually adjusted hardware input mechanisms. In this manner, the user may also pre-adjust the audio output to better match their needs and/or preferences and for the environment.

As shown in the example of FIG. 2, static parameter selector 132 can be arranged to be automatically configured, for example, by inputs from one or more detectors 138. Thus, for example, in accordance with certain implementations, speaker 106 may be configured to provide identifying information and/or correction parameters to detector 138 using an input 142. Speaker 106 can, for example, include a ROM or the like that can be read by detector 138. Detector 138 would then provide the learned information to static parameter selector 132. This could occur during an initialization or startup phase associated with the operation of system 100.

In accordance with certain further implementations of the present invention, a dynamic parameter selector 136 may also be provided in audio processing device 102. Dynamic parameter selector 136 is configured to provide for dynamic updating of parameter code 130 as allowed by rule book logic 134. Thus, for example, the user may manually change a parameter or setting on-the-fly using dynamic parameter selector 136. Thus, dynamic parameter selector 136 may include or otherwise interface with a GUI or other manual user input mechanism. The outputs from dynamic parameter selector 136 are provided to and handled by rule book logic 134, which may then dynamically change one or more corresponding parameters/setting in parameter code 130 in response, or decline to make changes that fall outside of the defining rules.

Dynamic parameter selector 136 is also illustrated as being connected to detector 138, through which, for example, dynamic changes can be identified. In certain implementations, detector 138 provides dynamic information about data 120, as illustrated by the dashed line 140 between memory 122 and detector 138. In this manner, for example, the applicable content of data 120 may be determined and applicable dynamic parameter changes made to rule book logic 134 by dynamic parameter selector 136. As described in subsequent sections, different types or forms or source data 120 may be suited for special correction/equalization. Thus, for example, different correction signatures may be desirable depending on the digital sampling rate of data 120. Hence, the sampling rate or other useful information can be included within, and/or determined from, data 120. Detector 138 may be configured to alert dynamic parameter selector 136 when data 120 undergoes certain changes that warrant dynamic changes to one or more parameters in parameter code 130.

In still other implementations of the present invention, detector 138 can be configured to collect/receive feedback from the speakers and/or environment wherein the audio signal is eventually being reproduced. Thus, for example, detector 138 may include one or more microphones that pick-up audio within the environment and associated interfacing logic/tools that identify dynamic parameter changes that may improve the user experience. In certain other implantations, detector 138 may include environment position monitoring mechanisms that provide feedback to dynamic parameter selector 136 regarding the physical arrangement of speaker(s) 106 and/or a user within the environment. Hence, a user position detecting mechanism may be employed to provide information about the relative location of the user with regard to the speaker(s) 106, such that special filtering parameters may be introduced by dynamic parameter selector 136 to rule book logic 134 that modify the parameter code (e.g., add time change/delay functionality) and speaker correction logic operation and therefore the resulting audio output by the speaker(s) 106.

While static parameter selector 132 and dynamic parameter selector 136 are illustrated in FIG. 2 as being separate logic modules, this is only to represent that some changes may be “static” while others may be dynamic. Thus, it is noted that in certain other implementations, static parameter selector 132 and dynamic parameter selector 136 are combined into a single parameter selector (not shown) logic module.

Reference is now made to FIG. 3, which a flow diagram illustrating an exemplary process 200 that can be implemented in audio processing device 102, for example, as in FIG. 2, in accordance with certain implementations of the present invention.

Here, in act 202, static and/or dynamic parameter changes are determined or otherwise identified. In act 204, rules that are established for system 100 and/or speaker(s) 106 are then enforced on the determined parameters. Consequently, if a parameter change is allowed under the rules in act 204, then in act 206 one or more parameters are added and/or modified appropriately in establishing parameter code 130. In act 208, the resulting parameter code is used to adjust at least a portion of the audio signal. Act 202 includes a recursive arrow, which represents that there may be on-going, dynamic changes that affect parameters within parameter code 130.

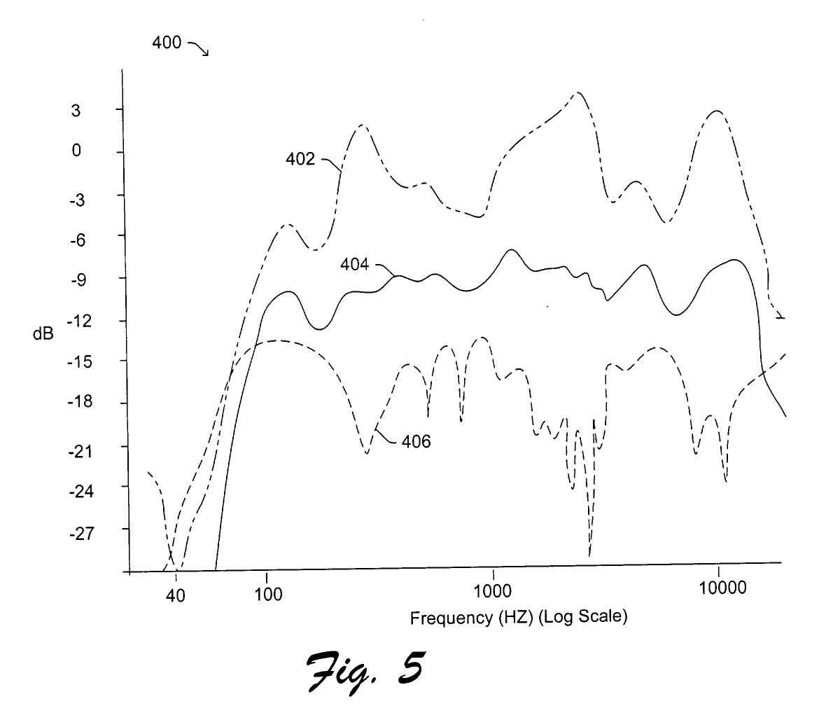

FIG. 5 is a graph 400 depicting the transfer function response of an audio reproduction system, for example, as in FIG. 1, for an audio signal having frequencies between about 30 Hz and about 20,000 Hz, and with (line 404) and without (line 402) the correction signature/parameters (line 406) applied, in accordance with certain exemplary implementations of the present invention.

The input data 120 (see, e.g., FIG. 2) that produced these exemplary plots and subsequent graphs herein, was a MLSSA™ (maximum-length sequences system analyzer) test signal, which is commonly used in audio reproduction testing. More information on MLSSA™ can be had from DRA Laboratories of Sarasota, Fla., for example.

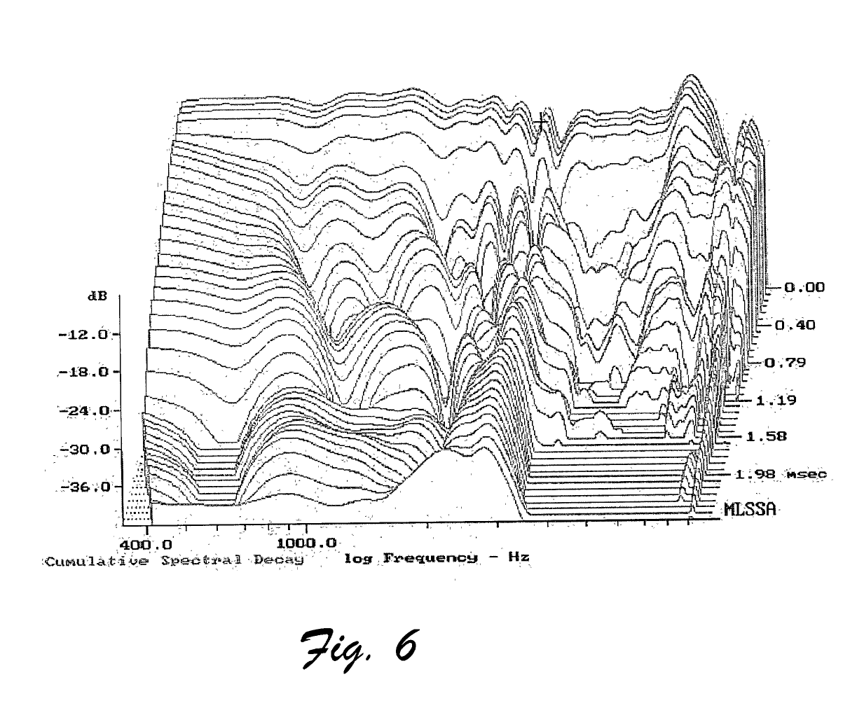

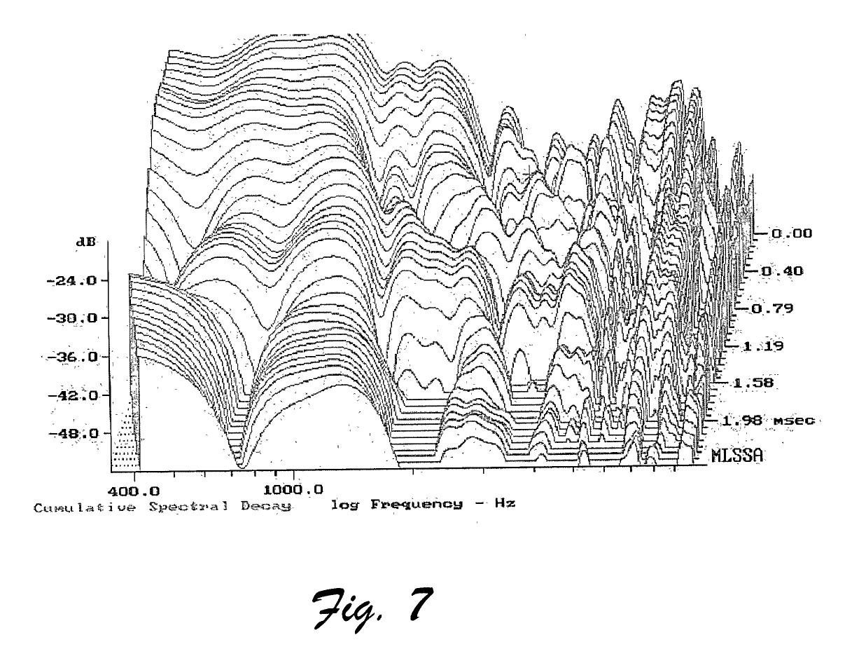

Line 402 shows the resulting magnitude of the transfer function before any correction is applied by speaker correction logic 124. Line 406 illustrates one exemplary correction signature as a result of parameter code 130 as pre-adjusted for the particular speaker 106. Here, as will be illustrated by example in. the related waterfall graphs in FIGS. 6 and 7, parameters where established to correct for unwanted coloration that occurred between about 400 Hz and about 1000 Hz, cone cry that occurred at between about 2000 Hz and 3000 Hz, and for other perceived audio problems. Thus, line 406 illustrates that some desirable audio frequencies are boosted (higher gain settings) and that some less desirable frequencies are cut (lower gain settings). In certain instances, there is also a shift in energy from certain frequencies to adjacent/neighboring frequencies to improve the sonic balance for a given system/speaker/user/environment. Line 404 illustrates what appeared to be a sonically improved output, which in this experiment tended to be more flat than the uncorrected signal in line 402.

For the experimental results presented herein, perceptual/manual testing was conducted to record and identify certain frequencies that tended to reduce and/or enhance the audible experience for the tester. From this testing applicable parameters and at least one correction signature was produced. One useful method for discovering such parameters and signature was to test the system and time-energy plot (“waterfall”) and/or other similar diagrams of the sound output by the speaker(s). Two such exemplary waterfall diagrams are depicted in FIGS. 6 and 7.

FIG. 6, by way of example, is a waterfall graph depicting the cumulative spectral decay of the sound from an audio reproduction system processing an audio signal without correction, which illustrates, for example, internal reflections between about 800 Hz and about 2000 Hz, counterproductive interference at about 2200 Hz, breakup modes at about 3000 Hz, and resonance at about 6500 Hz, for example, associated with a speaker arrangement and measured at an off axis, listener position, in accordance with certain exemplary implementations of the present invention.

FIG. 7 is a waterfall graph depicting the cumulative spectral decay of an audio reproduction system processing an audio signal without correction, which illustrates, for example, certain frequencies or frequency bands at about 500 Hz, 1100 Hz, 3000 Hz, 4500 Hz, 7000 Hz, and 8000 Hz, for example, which may appear in certain correction responses. The data in FIG. 7 is associated with sound output by a speaker arrangement that was measured at a listener position after at least partially bouncing off from a wall or off of a supporting horizontal surface (e.g., a table, desk top, shelf, etc.), in accordance with certain implementations of the present invention.

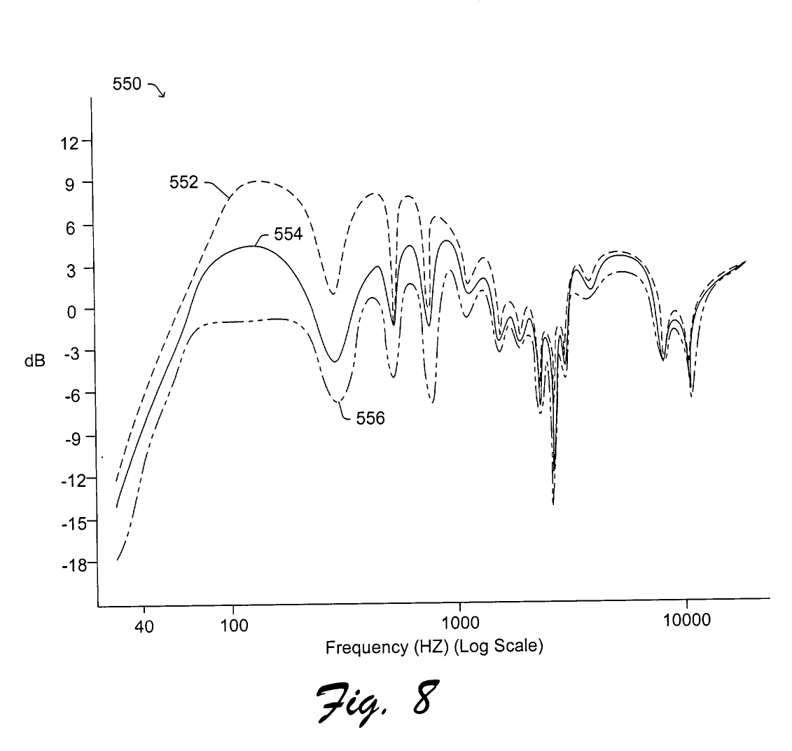

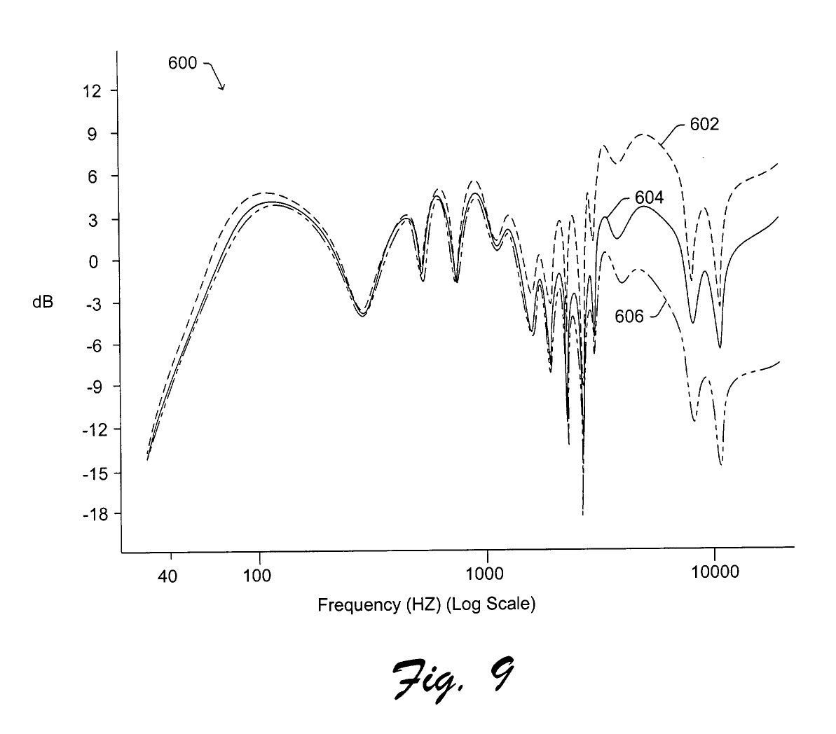

FIG. 8 is a graph 550 depicting a range of transfer function responses of an audio reproduction system, for example, as in FIG. 1, for certain lower frequencies of an audio signal having frequencies between about 30 Hz and about 20,000 Hz, and with exemplary correction applied, in accordance with certain implementations of the present invention.

Here, for example, lines 552 and 556 illustrate the maximum and minimum settings, respectively, following correction based on parameter code 130 for the lower frequencies (e.g., bass frequencies) of a MLSSA test signal. For comparison, line 554 illustrates a flat (e.g., neutral or default) response, which is the same as the correction. Line 552 illustrates the maximum bass or low frequency boost, which illustrates that the correction may not only further increase the magnitude of the energy at certain frequencies, but may also increase/decrease the energy at nearby frequencies. For example, comparing lines 552 and 554 one will notice that at about 120 Hz, the boosting upward towards line 552 further causes an increase/shift of energy to slightly higher frequencies at about 150 Hz. In certain instances, for example, lower bass frequencies may receive less boost than mid-bass frequencies. Comparing line 554 to line 556, the minimum bass setting extends and attenuates the peak of line 554 at about 120 HZ to between about 80 Hz and about 200 Hz.

In certain implementations, data associated with lines 552 and 556 are used to define rules within rule book logic 134 for a particular system, speaker, user, and/or environment.

FIG. 9 is a similar graph 600 depicting a range of transfer function responses of an audio reproduction system, for example, as in FIG. 1, for certain upper frequencies (e.g., treble frequencies) of an audio signal having frequencies between about 40 Hz and about 20,000 Hz, and with exemplary correction applied, in accordance with certain implementations of the present invention.

In this example, line 604 represents a flat (e.g., neutral or default) response showing a potential correction curve for the given system, speaker, user and/or environment. Line 602 illustrates the maximum settings and line 606 illustrates the minimum settings. As with the previous example, not only are certain frequencies boosted or cut, but there is also some shifting of energy to nearby frequencies at times. As mentioned previously, in certain implementations Q values for filters that are applied to certain frequencies may be set to produce the desired results.

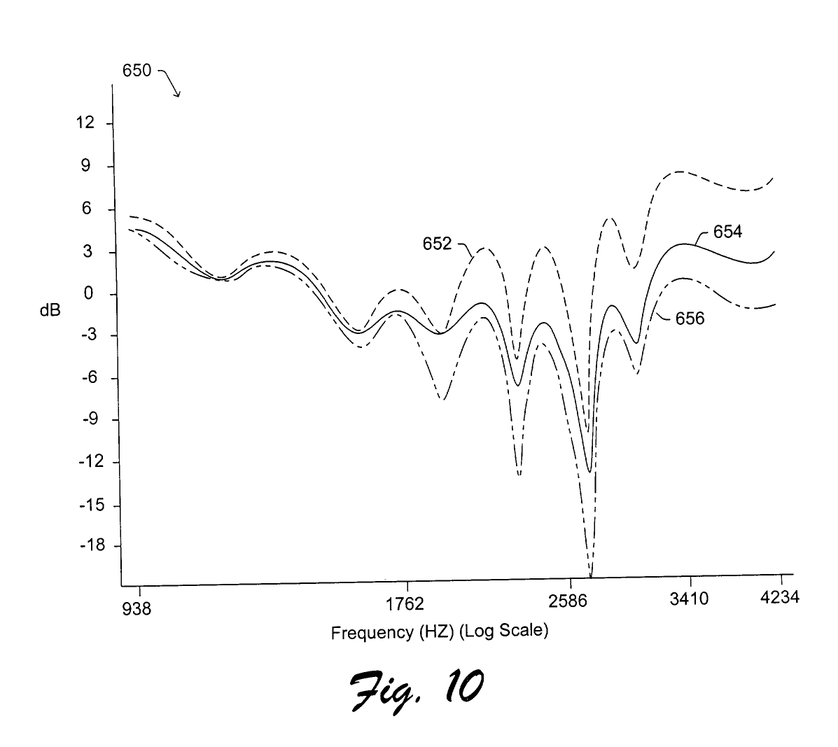

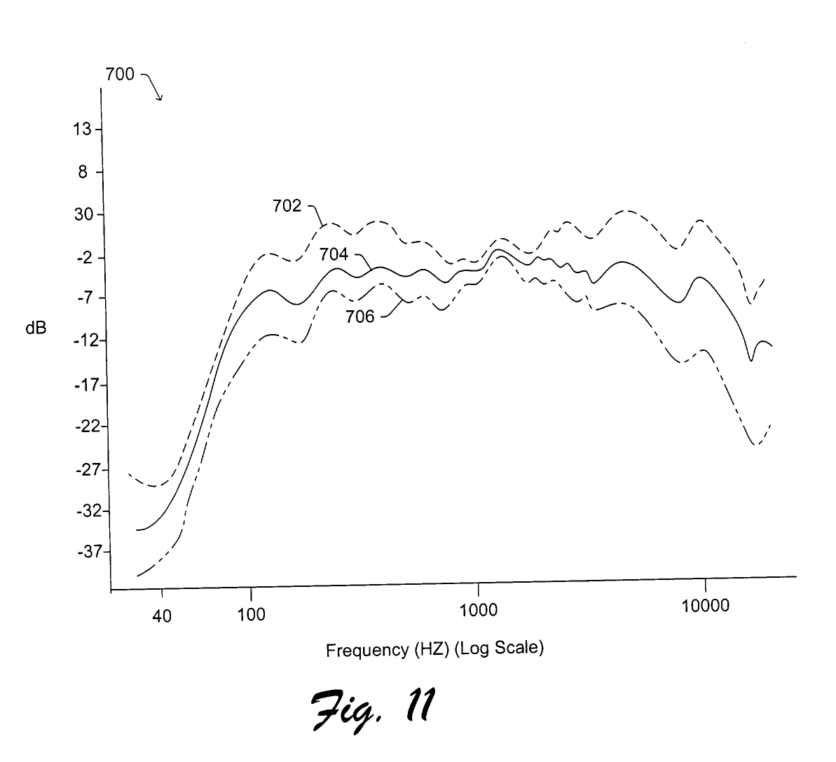

FIG. 10 is a similar graph 650 depicting in some greater detail a range of transfer function responses of an audio reproduction system, for example, as in FIG. 1, for certain upper frequencies (i.e., about 940 Hz to about 4234 Hz) of an audio signal having frequencies between about 30 Hz and about 20,000 Hz. Here, exemplary correction is being applied, in accordance with certain implementations of the present invention. Line 654 illustrates the flat response of the correction curve, line 652 illustrates the maximum treble boost settings and line 656 illustrates the minimum treble settings. Graph 650 illustrates the notch adjustments made to reduce/eliminate cone cry, for example, between about 1762 Hz and about 3410 Hz.

FIG. 11 is a graph 700 depicting an exemplary acoustic response of a speaker arrangement for different toned control settings of an audio reproduction system, for example, as in FIG. 1, with correction applied, in accordance with certain implementations of the present invention. Here, line 704 illustrates a flat response setting of the correction, line 702 illustrates the maximum settings and line 706 illustrates the minimum settings. Note that in this example there is a potential for boosting, cutting and/or shifting energy levels at all frequencies and more particularly at the lower and higher frequencies shown.

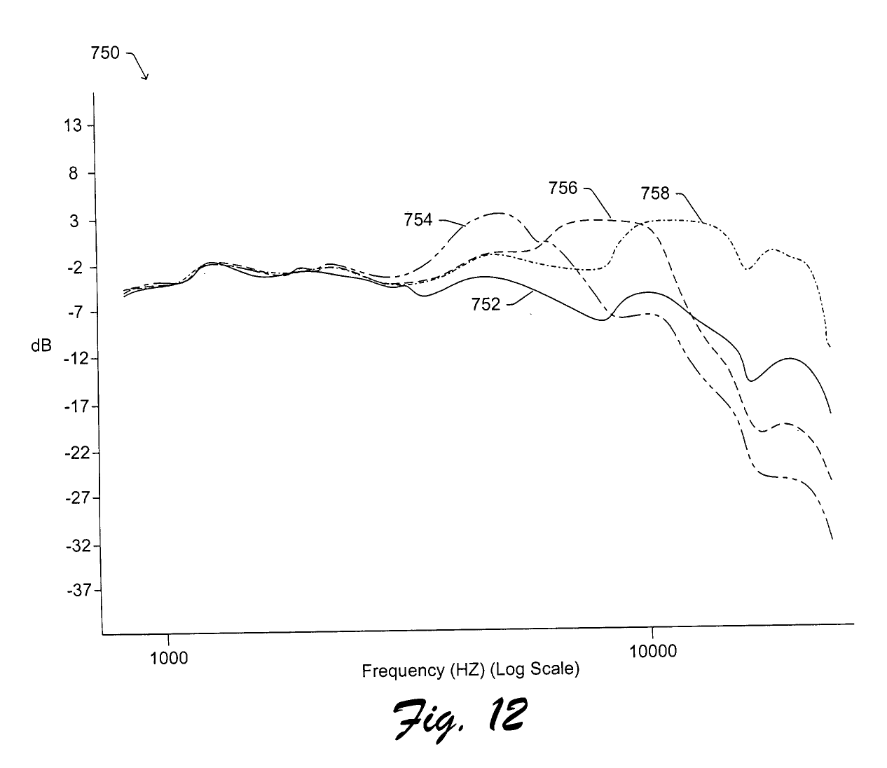

FIG. 12 is a graph 750 depicting an exemplary acoustic response of a speaker arrangement of an audio reproduction system, for example, as in FIG. 1, for different audio source signals and/or the needs of the user with correction applied accordingly, in accordance with certain further implementations of the present invention. Here, different correction curves are applied to the audio signal depending on the source of the signal. Line 752 illustrates the original speaker response intended for reproducing a 44 kHz sampled program or signal. Line 754 illustrates correction that can be applied to adjust the communication quality of a digital audio signal having a relatively low sampling rate of about 22 kHz. Line 756 illustrates correction that can be applied to adjust the communication quality of a digital audio signal having a somewhat higher sampling rate of about 36 kHz. Line 758 illustrates correction that can be applied to adjust the communication quality of a digital audio signal having an even higher sampling rate of about 44 kHz.

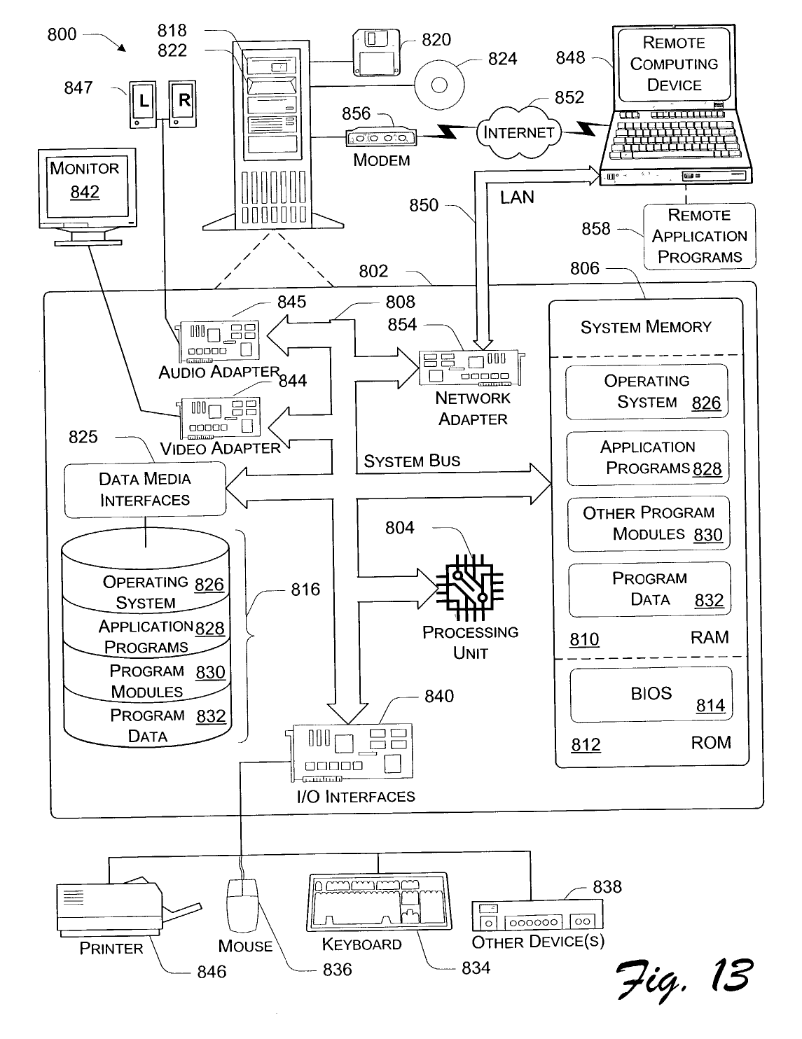

FIG. 13 illustrates a more general exemplary computer environment 800, which can be used in various implementations of the invention. The computer environment 800 is only one example of a computing environment and is not intended to suggest any limitation as to the scope of use or functionality of the computer and network architectures. Neither should the computer environment 800 be interpreted as having any dependency or requirement relating to any one or combination of components illustrated in the exemplary computer environment 800.

Computer environment 800 includes a general-purpose computing device in the form of a computer 802. Computer 802 can be configured, for example, to act as audio reproduction system 100 and/or audio processing device 102 of FIG. 1. Computer 802 represents any of a wide variety of computing devices, such as a personal computer, server computer, hand-held or laptop device, multiprocessor system, microprocessor-based system, programmable consumer electronics (e.g., digital video recorders), gaming console, cellular telephone, network PC, minicomputers, mainframe computer, distributed computing environment that include any of the above systems or devices, and the like.

The components of computer 802 can include, but are not limited to, one or more processors or processing units 804, a system memory 806, and a system bus 808 that couples various system components including the processor 804 to the system memory 806. The system bus 808 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 802 typically includes a variety of computer readable media. Such media can be any available media that is accessible by computer 802 and includes both volatile and non-volatile media, removable and non-removable media.

The system memory 806 includes computer readable media in the form of volatile memory, such as random access memory (RAM) 810, and/or non-volatile memory, such as read only memory (ROM) 812. A basic input/output system (BIOS) 814, containing the basic routines that help to transfer information between elements within computer 802, such as during start-up, is stored in ROM 812. RAM 810 typically contains data and/or program modules that are immediately accessible to and/or presently operated on by the processing unit 804.

Computer 802 may also include other removable/non-removable, volatile/non-volatile computer storage media. By way of example, FIG. 7 illustrates a hard disk drive 816 for reading from and writing to a non-removable, non-volatile magnetic media (not shown), a magnetic disk drive 818 for reading from and writing to a removable, non-volatile magnetic disk 820 (e.g., a “floppy disk”), and an optical disk drive 822 for reading from and/or writing to a removable, non-volatile optical disk 824 such as a CD-ROM, DVD-ROM, or other optical media. The hard disk drive 816, magnetic disk drive 818, and optical disk drive 822 are each connected to the system bus 808 by one or more data media interfaces 825. Alternatively, the hard disk drive 816, magnetic disk drive 818, and optical disk drive 822 can be connected to the system bus 808 by one or more interfaces (not shown).

The disk drives and their associated computer-readable media provide non-volatile storage of computer readable instructions, data structures, program modules, and other data for computer 802. Although the example illustrates a hard disk 816, a removable magnetic disk 820, and a removable optical disk 824, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 816, magnetic disk 820, optical disk 824, ROM 812, and/or RAM 810, including by way of example, an operating system 826, one or more application programs 828, other program modules 830, and program data 832. Each of such operating system 826, one or more application programs 828, other program modules 830, and program data 832 (or some combination thereof) may implement all or part of the resident components that support the distributed file system.

A user can enter commands and information into computer 802 via input devices such as a keyboard 834 and a pointing device 836 (e.g., a “mouse”). Other input devices 838 (not shown specifically) may include a microphone, joystick, game pad, satellite dish, serial port, scanner, and/or the like. These and other input devices are connected to the processing unit 804 via input/output interfaces 840 that are coupled to the system bus 808, but may be connected by other interface and bus structures, such as a parallel port, game port, or a universal serial bus (USB).

A monitor 842 or other type of display device can also be connected to the system bus 808 via an interface, such as a video adapter 844. In addition to the monitor 842, other output peripheral devices can include components such as stereo left (L) and right (R) speakers 847 (and/or other combinations of speakers) that can be connected via an audio adapter 845 or like circuitry to computer 802. A printer 846 may also be provided and connected to computer 802 via the input/output interfaces 840.

Computer 802 can operate in a networked environment using logical connections to one or more remote computers, such as a remote computing device 848. By way of example, the remote computing device 848 can be a personal computer, portable computer, a server, a router, a network computer, a peer device or other common network node, and the like. The remote computing device 848 is illustrated as a portable computer that can include many or all of the elements and features described herein relative to computer 802.

Logical connections between computer 802 and the remote computer 848 are depicted as a local area network (LAN) 850 and a general wide area network (WAN) 852. Such networking environments are commonplace in offices, enterprise-wide computer networks, intranets, and the Internet.

When implemented in a LAN networking environment, the computer 802 is connected to a local network 850 via a network interface or adapter 854. When implemented in a WAN networking environment, the computer 802 typically includes a modem 856 or other means for establishing communications over the wide network 852. The modem 856, which can be internal or external to computer 802, can be connected to the system bus 808 via the input/output interfaces 840 or other appropriate mechanisms. It is to be appreciated that the illustrated network connections are exemplary and that other means of establishing communication link(s) between the computers 802 and 848 can be employed.

In a networked environment, such as that illustrated with computing environment 800, program modules depicted relative to the computer 802, or portions thereof, may be stored in a remote memory storage device. By way of example, remote application programs 858 reside on a memory device of remote computer 848. For purposes of illustration, application programs and other executable program components such as the operating system are illustrated herein as discrete blocks, although it is recognized that such programs and components reside at various times in different storage components of the computing device 802, and are executed by the data processor(s) of the computer.

Computer 802 typically includes at least some form of computer readable media. Computer readable media can be any available media that can be accessed by computer 802. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media a which can be used to store the desired information and which can be accessed by computer 802. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as wired network or direct-wired connection, and wireless media such as acoustic, RF, infrared and other wireless media. Combinations of any of the above should also be included within the scope of computer readable media.

The invention has been described herein in part in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various implementations.

For purposes of illustration, programs and other executable program components such as the operating system are illustrated herein as discrete blocks, although it is recognized that such programs and components reside at various times in different storage components of the computer, and are executed by the data processor(s) of the computer.

Alternatively, the invention may be implemented in hardware or a combination of hardware, software, and/or firmware. For example, one or more application specific integrated circuits (ASICs) could be designed or programmed to carry out the invention. In other implementations, analog circuitry may be used.

### CONCLUSION

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

What is claimed is:

1. A method comprising:
determining at least one audio signal parameter setting;
determining if said at least one audio signal parameter setting is allowable for a audio reproduction system configuration based at least in part on at least one rule associated with said audio reproduction system configuration; and
applying said at least one audio signal parameter setting to at least one portion of an audio data signal to modify said audio data signal.

2. The method as recited in claim 1, wherein said at least one audio signal parameter setting includes at least one speaker parameter setting associated with a speaker operatively arranged in said audio reproduction system configuration.

3. The method as recited in claim 1, wherein said at least one audio signal parameter setting includes at least one user controlled parameter setting associated with at least one user input mechanism in said audio reproduction system configuration.

4. The method as recited in claim 3, wherein said at least one user controlled parameter setting is selected from a group of user controlled parameter settings including a user hearing capability setting and a user preference setting.

5. The method as recited in claim 3, wherein said at least one user input mechanism includes an adjustable electrical input mechanism.

6. The method as recited in claim 1, wherein said at least one audio signal parameter setting includes at least one environment based parameter setting associated with an operating environment associated with said audio reproduction system configuration.

7. The method as recited in claim 1, wherein said at least one audio signal parameter setting includes at least one detectable parameter setting associated with at least one detector operatively arranged within said audio reproduction system configuration.

8. The method as recited in claim 1, wherein said at least one audio signal parameter provides feedback to said audio reproduction system configuration.

9. The method as recited in claim 1, wherein said at least one audio signal parameter includes at least one audio source signal identifying parameter associated with said audio data signal.

10. The method as recited in claim 1, wherein said audio data signal includes digital data.

11. The method as recited in claim 1, wherein said audio data signal includes analog data.

12. The method as recited in claim 1, wherein said at least one audio signal parameter is static during an operating period.

13. The method as recited in claim 1, wherein said at least one audio signal parameter is dynamic during an operating period.

14. The method as recited in claim 1, wherein determining if said at least one audio signal parameter setting is allowable for said audio reproduction system configuration based at least in part on said at least one rule associated with said audio reproduction system configuration further includes:
determining if said at least one audio signal parameter setting falls with an allowable operating range.

15. The method as recited in claim 14, wherein said allowable operating range in defined by at least one limiting gain setting selected from a group comprising a minimum gain setting and a maximum gain setting.

16. The method as recited in claim 14, wherein said allowable operating range is associated with a portion of said audio data signal corresponding to at least one audio frequency and said at least one audio signal parameter setting establishes a gain setting for said audio data signal at said at least one audio frequency.

17. The method as recited in claim 16, wherein said gain setting is specified in dB.

18. The method as recited in claim 1, wherein determining if said at least one audio signal parameter setting is allowable for said audio reproduction system configuration based at least in part on said at least one rule associated with said audio reproduction system configuration further includes:
selectively modifying said at least one rule.

19. The method as recited in claim 1, wherein applying said at least one audio signal parameter setting to said at least one portion of said audio data signal to modify said audio data signal further includes:
modifying a gain associated with at least one frequency within an audible sound output.

20. The method as recited in claim 1, wherein applying said at least one audio signal parameter setting to said at least one portion of said audio data signal to modify said audio data signal further includes:
establishing corresponding parameter code.

21. The method as recited in claim 20, wherein said corresponding parameter code is configured to operatively control audio correction logic.

22. The method as recited in claim 20, wherein audio correction logic includes digital signal processing (DSP) logic.

23. The method as recited in claim 20, wherein said parameter code includes information selected from a group of information comprising a parameter identifier, a frequency, a gain setting, a Q setting, and a group identifier.

24. A computer-readable medium having computer-executable instructions for performing acts comprising:
establishing at least one audio signal parameter setting; and
applying said at least one audio signal parameter setting to at least one portion of an audio data signal to modify said audio data signal, if said at least one audio signal parameter setting is allowable for a audio reproduction system configuration based at least in part on at least one rule associated with said audio reproduction system configuration.

25. The computer-readable medium as recited in claim 24, wherein said at least one audio signal parameter setting is selected from a group of audio signal parameter settings comprising a speaker parameter setting associated with a speaker operatively arranged in said audio reproduction system configuration, a user controlled parameter setting associated with at least one user input mechanism in said audio reproduction system configuration, an environment based parameter setting associated with an operating environment associated with said audio reproduction system configuration, and a detectable parameter setting associated with at least one detector operatively arranged within said audio reproduction system configuration.

26. The computer-readable medium as recited in claim 25, wherein said user controlled parameter setting is selected from a group of user controlled parameter settings including a user hearing capability setting and a user preference setting.

27. The computer-readable medium as recited in claim 26, wherein said at least one user input mechanism includes an adjustable electrical input mechanism.

28. The computer-readable medium as recited in claim 24, wherein said at least one audio signal parameter provides feedback to said audio reproduction system configuration.

29. The computer-readable medium as recited in claim 23, wherein said at least one audio signal parameter includes at least one audio source signal identifying parameter associated with said audio data signal.

30. The computer-readable medium as recited in claim 23, wherein said at least one audio signal parameter is static during an operating period.

31. The computer-readable medium as recited in claim 23, wherein said at least one audio signal parameter is dynamic during an operating period.

32. The computer-readable medium as recited in claim 23, having computer-executable instructions for performing further acts comprising:
determining if said at least one audio signal parameter setting falls with an allowable operating range.

33. The computer-readable medium as recited in claim 32, wherein said allowable operating range in defined by at least one limiting gain setting selected from a group comprising a minimum gain setting and a maximum gain setting.

34. The computer-readable medium as recited in claim 32, wherein said allowable operating range is associated with a portion of said audio data signal corresponding to at least one audio frequency and said at least one audio signal parameter setting establishes a gain setting for said audio data signal at said at least one audio frequency.

35. The computer-readable medium as recited in claim 34, wherein said gain setting is specified in dB.

36. The computer-readable medium as recited in claim 24, having computer-executable instructions for performing further acts comprising:
selectively modifying said at least one rule.

37. The computer-readable medium as recited in claim 24, wherein applying said at least one audio signal parameter setting to said at least one portion of said audio data signal to modify said audio data signal further includes:
modifying a gain associated with at least one frequency within an audible sound output.

38. The computer-readable medium as recited in claim 24, wherein applying said at least one audio signal parameter setting to said at least one portion of said audio data signal to modify said audio data signal further includes:
establishing corresponding parameter code.

39. The computer-readable medium as recited in claim 38, wherein said corresponding parameter code is configurable to operatively control audio correction logic.

40. The computer-readable medium as recited in claim 38, wherein said parameter code includes information selected from a group of information comprising a parameter identifier, a frequency, a gain setting, a Q setting, and a group identifier.

41. An apparatus comprising:
parameter selecting logic configured to determine at least one audio signal parameter setting;
rule book logic operatively coupled to said parameter selecting logic and configured to determine if said at least one audio signal parameter setting is allowable for a audio reproduction system configuration based at least in part on at least one rule associated with said audio reproduction system configuration, and configured to output parameter code; and
correction logic operatively configured to receive an audio data signal and said parameter code, and apply said at least one audio signal parameter setting in said parameter code to at least one portion of said audio data signal to modify said audio data signal.

42. The apparatus as recited in claim 41, wherein said at least one audio signal parameter setting includes at least one speaker parameter setting.

43. The apparatus as recited in claim 41, wherein said at least one audio signal parameter setting includes at least one user controlled parameter setting.

44. The apparatus as recited in claim 43, wherein said at least one user controlled parameter setting is selected from a group of user controlled parameter settings including a user hearing capability setting and a user preference setting.

45. The apparatus as recited in claim 41, wherein said at least one audio signal parameter setting includes at least one environment based parameter setting.

46. The apparatus as recited in claim 41, wherein said at least one audio signal parameter setting includes at least one detectable parameter setting.

47. The apparatus as recited in claim 41, wherein said at least one audio signal parameter includes feedback to said parameter selecting logic.

48. The apparatus as recited in claim 41, wherein said at least one audio signal parameter includes at least one audio source signal identifying parameter associated with said audio data signal.

49. The apparatus as recited in claim 41, wherein said audio data signal includes digital data.

50. The apparatus as recited in claim 41, wherein said audio data signal includes analog data.

51. The apparatus as recited in claim 41, wherein said at least one audio signal parameter is static during an operating period.

52. The apparatus as recited in claim 41, wherein said at least one audio signal parameter is dynamic during an operating period.

53. The apparatus as recited in claim 41, wherein said rule book logic is configured to determine if said at least one audio signal parameter setting falls with an allowable operating range.

54. The apparatus as recited in claim 53, wherein said allowable operating range in defined by at least one limiting gain setting selected from a group comprising a minimum gain setting and a maximum gain setting.

55. The apparatus as recited in claim 53, wherein said allowable operating range is associated with a portion of said audio data signal corresponding to at least one audio frequency and said at least one audio signal parameter setting establishes a gain setting for said audio data signal at said at least one audio frequency.

56. The apparatus as recited in claim 55, wherein said gain setting is specified in dB.

57. The apparatus as recited in claim 41, wherein said rule book logic is configured to selectively modify said at least one rule.

58. The apparatus as recited in claim 41, wherein said correction logic is configured to modify a gain associated with at least one frequency within an audible sound output.

59. The apparatus as recited in claim 41, wherein said parameter code is configured to operatively control said correction logic.

60. The apparatus as recited in claim 60, wherein said correction logic includes digital signal processing (DSP) logic.

61. The apparatus as recited in claim 60, wherein said parameter code includes information selected from a group of information comprising a parameter identifier, a frequency, a gain setting, a Q setting, and a group identifier.
